(19) United States
(12) Patent Application Publication
(10) Pub. No.: US 2013/0057899 A1
(43) Pub. Date: Mar. 7, 2013

(54) IMAGE FORMING APPARATUS AND DATA MANAGEMENT METHOD

(71) Applicant: Takanori Fukuhara, Shizuoka-ken (JP)

(72) Inventor: Takanori Fukuhara, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/603,624

(22) Filed: Sep. 5, 2012

Related U.S. Application Data
(60) Provisional application No. 61/531,214, filed on Sep. 6, 2011.

(51) Int. Cl. G06K 15/02

(52) U.S. Cl. 358/1.14; 358/1.15

(57) ABSTRACT

An image forming apparatus includes: an operation input acquiring section which acquires operation input instructing temporary data of an image process object generated temporarily to be overwrote and erased with predetermined data; a temporary data erasing section which performs an erasing process in which the temporary data to be overwrote and erased with predetermined data; a temporary data management section which manages in a predetermined storage area temporary data management information including at least information of whether or not the temporary data is erased; a temporary data management information acquiring section which acquires from the predetermined storage area the temporary data management information; and a display control section which displays on a screen the information of whether or not the temporary data is erased in the temporary data erasing section, correlated with history information of the job corresponding to the temporary data, based on the temporary data management information.

### CROSS-REFERENCE TO RELATED APPLICATIONS

This application is based upon and claims the benefit of priority from U.S. provisional application 61/531,214, filed on Sep. 6, 2011; the entire contents of which are incorporated herein by reference.

### FIELD

Embodiments described herein relate generally to a data management method in an image forming apparatus.

### BACKGROUND

An image forming apparatus such as an MFP (Multi Function Peripheral) generates image data in a bitmap format based on a print job and the image data is temporarily stored on a hard disk drive (HDD) of the image forming apparatus or the like until an image forming process starts using the image data, in a print process based on the print job from a client terminal . Further, image data, which is generated by reading an original document, is also temporarily stored on the HDD or the like in a copy process.

In the image forming apparatus, the image data generated temporarily for the image forming process is preserved in a area for temporary saving formed on the HDD or the like. The image data temporarily generated may be overwrote by different image data or may remain as is.

For example, if high security information is included in the image data remaining as is, the high security information may be leaked.

### DESCRIPTION OF THE DRAWINGS

FIG. 1 is a system configuration view illustrating a system configuration of an image forming apparatus.

FIG. 2 is a view illustrating an example of a data structure of an auxiliary storage device in an image forming apparatus of an exemplary embodiment.

FIG. 3 is a functional block diagram illustrating function of the image forming apparatus.

FIG. 4 is a view illustrating an example of a job history screen.

FIG. 5 is a flowchart illustrating a flow of a management process of temporary data.

### DETAILED DESCRIPTION

Hereinafter, according to an exemplary embodiment, an image forming apparatus includes an operation input acquiring section, a temporary data erasing section, a temporary data management section, a temporary data management information acquiring section and a display control section. The operation input acquiring section acquires an operation input which instructs to overwrite and erase temporary data of an image processing object which is temporarily generated according to the execution of a job with predetermined data. The temporary data erasing section performs an erasing process to overwrite and erase the temporary data which is designated by the operation input with the predetermined data. The temporary data management section manages in a predetermined storage area temporary data management information at least including information on whether or not the temporary data is erased by the temporary data erasing section. The temporary data management information acquiring section acquires from the predetermined storage area the temporary data management information managed by the temporary data management section. The display control section displays on a screen the information on whether or not the temporary data is erased by the temporary data erasing section, correlated with history information of the job corresponding to the temporary data, based on the temporary data management information acquired in the temporary data management information acquiring section.

Hereinafter, the exemplary embodiment is described with reference to the drawings.

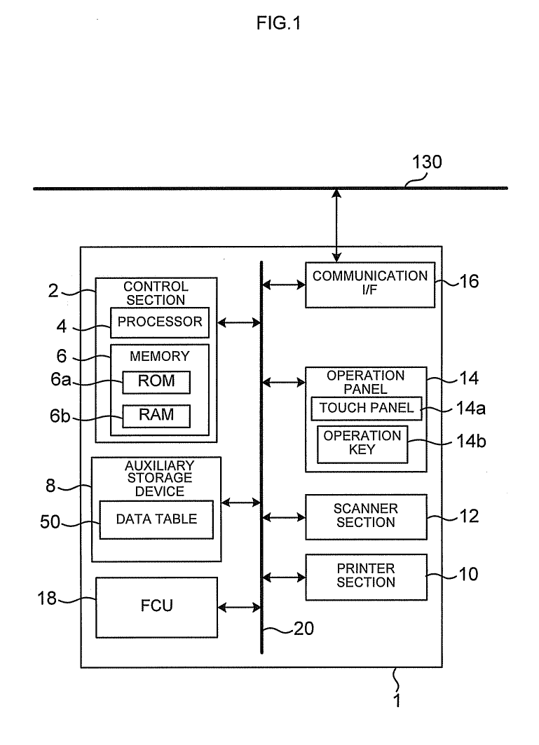

FIG. 1 is a system configuration view illustrating the system configuration of an image forming apparatus 1.

The image forming apparatus 1 includes a control section 2, an auxiliary storage device 8, a printer section 10, a scanner section 12, an operation panel 14, a communication interface (a communication I/F) 16 and a facsimile control unit (FCU) 18. Each component of the image forming apparatus 1 is connected via a bus 20.

The control section 2 functions through a processor 4, a memory 6 and an operating system (OS).

The processor 4 is a CPU (Central Processing Unit) or an MPU (Micro Processing Unit).

The memory 6 is, for example, a semiconductor memory. The memory 6 includes a ROM (Read Only Memory) 6a which stores a control program of the processor 4 and, a RAM (Random Access Memory) 6b which provides a temporary work area to the processor 4.

The control section 2 controls the printer section 10, the scanner section 12, the operation panel 14, the communication I/F 16, the FCU 18 or the like, based on the program which is accommodated in the ROM 6a or the auxiliary storage device 8. Furthermore, the control section 2 of the exemplary embodiment performs a management process of data temporarily stored in the auxiliary storage device 8, based on a data management program. Detailed description of the process using the data management program is provided below.

The image forming apparatus 1 may include an ASIC (Application Specific Integrated Circuit) as the control section 2 and a portion or all of the functions of the control section 2 may be realized by the ASIC.

The auxiliary storage device 8 stores various programs or data. The auxiliary storage device 8 stores for example, application programs and the OS. The application programs include a program which executes the function included in the image forming apparatus 1, such as copy function, print function, scanner function, facsimile function and network file function. The application programs further have an application for Web client (Web browser) or other applications.

Further, the auxiliary storage device 8 saves image data generated by reading original document in the scanner section 12 or the job history information that is a history of the jobs executed in the image forming apparatus 1. In addition, the auxiliary storage device 8 appropriately saves account information of a user, updates to a software, protected electronic documents, text data, policies or the like. The files are managed by a file system, such as FAT, in the auxiliary storage device 8.

Furthermore, the auxiliary storage device 8 of the exemplary embodiment temporarily saves image data (also, referred to as “temporary data”, below) of an image process object temporarily generated when performing an image forming process or an image process such as a scan. The temporary data includes image data (for example, bitmap data) generated when executing a print job transmitted from a client terminal, image data generated by scanning the original document in the copy process, image data generated by scanning in the scan process, or the like. In addition, the auxiliary storage device 8 of the exemplary embodiment stores temporary data management information managing the temporary data.

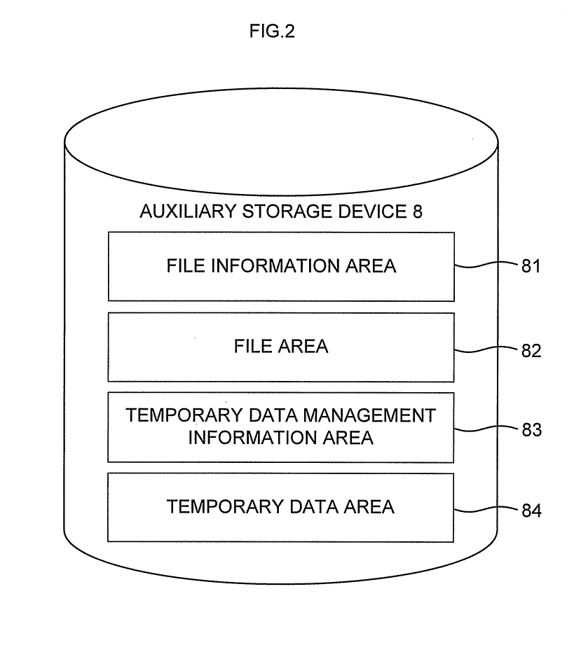

Here, FIG. 2 illustrates the data structure of the auxiliary storage device 8. The auxiliary storage device 8 includes a file information area 81, a file area 82, a temporary data management information area 83 and a temporary data area 84.

The file information area 81 is an area where management data such as position information of the files or the like required in the management of the files in the file system, such as FAT, is saved. The file area 82 is an area saving actual data of the files for which the position information or the like is managed in the file information area 81. The file area 82 saves various files or data such as the application programs, the OS, or the account information described above. In addition, the file information area 81 and the file area 82 have a data structure usually including the storage device in which the files are managed by the file system.

Next, the temporary data management information area 83 is an area saving the temporary data management information which manages the temporary data described above. The temporary data area 84 is an area saving the temporary data (for example, bitmap data, or the like).

The temporary data management information is information where information which specifies the position information or the temporary data of the temporary data saved in the temporary data area 84 in the auxiliary storage device 8 is correlated with the information of whether or not the overwriting and erasing process is completed on the temporary data. The temporary data is managed in the temporary data area 84 using the temporary data management information.

The information specifying the temporary data is for example, information such as type of job that is a source of the temporary data, file name, identification information (ID) of the user carried out the job, the date and time when the original job is generated, or the like.

The information of whether or not the overwriting and erasing process is completed is information showing that the overwriting and erasing process is performed on the temporary data or the overwriting and erasing process is not performed on the temporary data by the erasing process with respect to the temporary data described below.

The auxiliary storage device 8 may be for example, a magnetic storage device such as a hard disk drive, an optical storage device, a semiconductor storage device (a flash memory, or the like) or an arbitrary combination of the storage devices described above.

The printer section 10 forms an image on a sheet, based on the print job acquired from the client terminal or the like as the print process. In addition, during the copy process, an image is formed on the sheet, based on an image generated by reading the original document in the scanner section 12. The image formation is performed similarly when the FCU 18 receives the fax.

The scanner section 12 is a device for reading the original document. The scanner section 12 includes a scan reading unit which reads the original document as the image, an original document placing stand and an automatic original document transmitting device which transmits the original document to a reading position. The scan reading unit of the scanner section 12 reads the original document which is set on the original document placing stand or the automatic original document transmitting device.

The operation panel 14 is an operation unit where the user executes various operations or input with respect to the image forming apparatus 1 and is also a display unit of an operation situation of the image forming apparatus 1 or various setting screen. The operation panel 14 includes a touch panel 14a and various operation keys 14b. The touch panel 14a displays for example, setting contents or setting screens thereof regarding print conditions such as paper size, number of copies, print density settings or finishing (binding and folding). The operation keys 14b include for example, ten keys, a reset key, a stop key, a start key, or the like. The user may input and instruct from the touch panel 14a or the operation keys 14b so that instruction of various processes, the setting operation of the print conditions, or changing operation of the setting contents of the print conditions are executed.

In addition, in the exemplary embodiment, the input may be performed in the operation panel 14 to instruct that the overwriting and erasing process is carried out on the temporary data as described below. A screen which is displayed when instructing the execution of the overwriting and erasing process or an input method of instruction of the execution are described below in description of the management process function of the temporary data.

In addition, the image forming apparatus 1 may include other display devices or input devices instead of or in addition to the touch panel 14a or the operation keys 14b in the operation panel 14. As the input device, a pointing device such as a mouse, a keyboard or the like may be used.

The communication I/F 16 is interface connecting the image forming apparatus 1 and an other device on a network 130 such as the client terminal. In addition, the image forming apparatus 1 and an other outside machine may be connected via the communication I/F 16. The outside machine includes for example, an outside storage device such as a flash memory. The image forming apparatus 1 acquires image data from the outside storage device and then may perform a so-called direct print performing the image formation as is.

The communication I/F 16 connects for example, the image forming apparatus 1 and the device such as the client terminal using an appropriate wireless communication compliant with IEEE 802.15, IEEE 802.11, IEEE 802.3, IEEE 1284, IrDA or the like, such as Bluetooth (trademark), wireless LAN, infrared connection, and optical link, or wired communication in various formats. The communication I/F 16 includes a buffer and a portion or all of the received data is temporarily held in the buffer. Further, the communication executed via the communication I/F 16 is controlled by the control section 2.

The facsimile control unit (FCU) 20 controls a transmitting process and a receiving process of the facsimile in the image forming apparatus 1.

The network 130 may be any network if the image forming apparatus 1 may be communicated with the external device such as the client terminal and may be configured by a LAN (Local Area Network), a WAN (Wide Area Network) or the Internet.

Next, the management process of the temporary data generated temporarily during the image forming process in the image forming apparatus 1 is described. First, the function of the image forming apparatus 1 performing the management process of the temporary data is described.

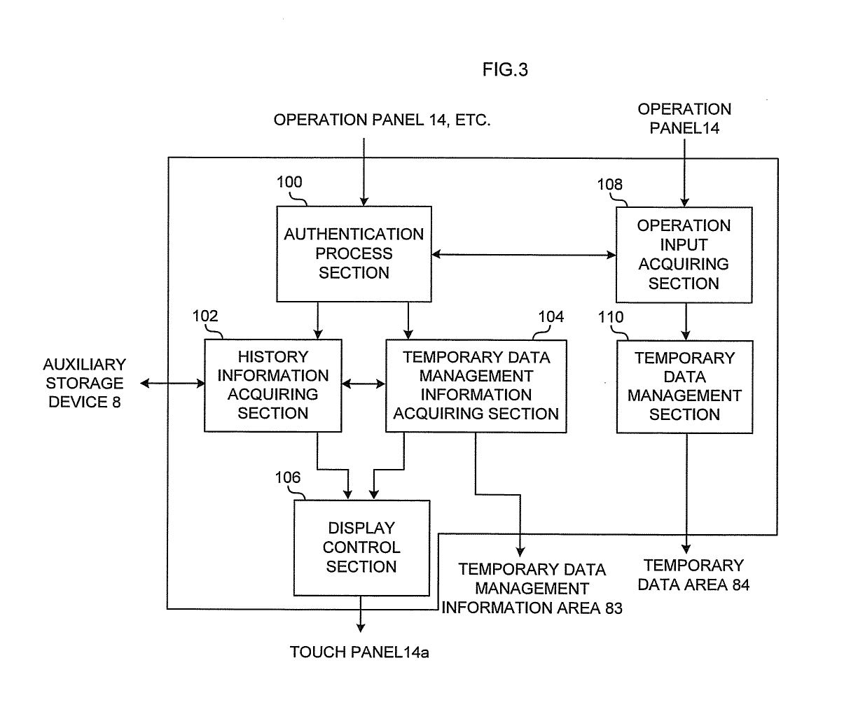

FIG. 3 is a functional block diagram illustrating the function of the image forming apparatus 1 of the exemplary embodiment. In addition, as described above, the processor 4 executes the data management program stored in the memory 6 (or the auxiliary storage device 8) and then the function of the image forming apparatus 1 illustrated in FIG. 3 is realized. A portion or all functions illustrated in FIG. 3 may be realized by the ASIC.

The image forming apparatus 1 includes a authentication process section 100, a history information acquiring section 102, a temporary data management information acquiring section 104, a display control section 106, an operation input acquiring section 108 and a temporary data management section 110. Below, each function is described.

The authentication process section 100 performs an authentication process of the user when starting the operation of the image forming apparatus 1. An authentication process method performed by the authentication process section 100 is not specifically limited, and for example, includes a method where the user inputs an ID (identification information of the user) and a password on the operation panel 14, a method where an ID card is read by a card reader, fingerprint authentication where a fingerprint of the user is read and then the authentication process is carried out, or the like. The authentication process section 100 acquires information required for login from the user using the methods described above. Thus, the authentication process section 100 refers to the account information which is managed in a predetermined database and then determines whether or not the input information is appropriate. If the information is appropriate, the user may use the image forming apparatus 1 (accepting the login). The account information may be stored in the auxiliary storage device 8 or may be managed by another device such as the server on the network.

The history information acquiring section 102 acquires the job history information required displaying on the screen of the operation panel 14 using history of the image forming apparatus 1. The job history information is information indicating content of the jobs executed until that time by the logged in ID. The job history information is saved being correlated with the ID of the user in the auxiliary storage device 8. The job history information is detailed information of each job, for example, the type of job including printing or copying, date and time when the job was generated, file name, or the like.

Further, the job history information may be managed by another device on the network 130.

The temporary data management information acquiring section 104 acquires the temporary data management information. Specifically, the temporary data management information acquiring section 104 acquires the temporary data management information of the temporary data generated when executing the job, which corresponds to the job being executed by the logged in user until that time. An acquiring method is configured such that firstly, the temporary data management information acquiring section 104 acquires information specifying the job being executed by the logged in user, based on the ID of the logged in user and the job history information acquired in the history information acquiring section 102. The information specifying the job is for example, the ID of the logged in user, type of job, date and time when the job was generated or the file name. The job being executed by the logged in user is specified by the plurality of information.

The temporary data management information acquiring section 104 acquires from the temporary data management information area 83 the temporary data management information of the temporary data corresponding to the specified job. The temporary data management information includes the information of whether or not the overwriting and erasing process is completed on the temporary data as described above. The position information where the corresponding temporary data is saved or the information specifying the temporary data, correlated with the job corresponding to the temporary data, may be correlated with each other.

Accordingly, the temporary data management information acquiring section 104 compares the information specifying the jobs executed by the user and the information specifying the temporary data included in the temporary data management information. For example, the temporary data management information of the temporary data corresponding to the job is specified and the temporary data management information is acquired, based on whether the file name, type of job, the date and time of the job match each other.

Here “the overwriting and erasing process” is a process where all temporary data corresponding to the specified job is overwrote and erased with predetermined data based on an instruction from the user. The overwriting predetermined data may be predetermined data, may be random data generated for each overwriting process, or may be any data if the temporary data is overwrote and erased so that the temporary data cannot be restored to the original state.

In the exemplary embodiment, “the overwriting and erasing process” means the erasing process carried out by the instruction (the input from the operation panel 14) from the user. Thus, a case where a portion or all the temporary data is overwrote incidentally by other temporary data generated when other job is executed is not included in the overwriting and erasing process. That is, in the temporary data management information area 83, whether or not the overwriting and erasing process is executed by the instruction from the user is managed, however, the practical state of the temporary data such as whether or not the overwriting is executed by other temporary data is not recorded.

The display control section 106 displays on the touch panel 14a the screen showing the history of the jobs executed by the user until that time and whether or not the overwriting and erasing process is completed on the temporary data corresponding to each job. Regarding the job history, the display control section 106 performs the display, based on the job history information acquired in the history information acquiring section 102. Further, regarding whether or not the overwriting and erasing process is completed on the temporary data corresponding to each job, the display control section 106 performs the display, based on the temporary data management information acquired in the temporary data management information acquiring section 104.

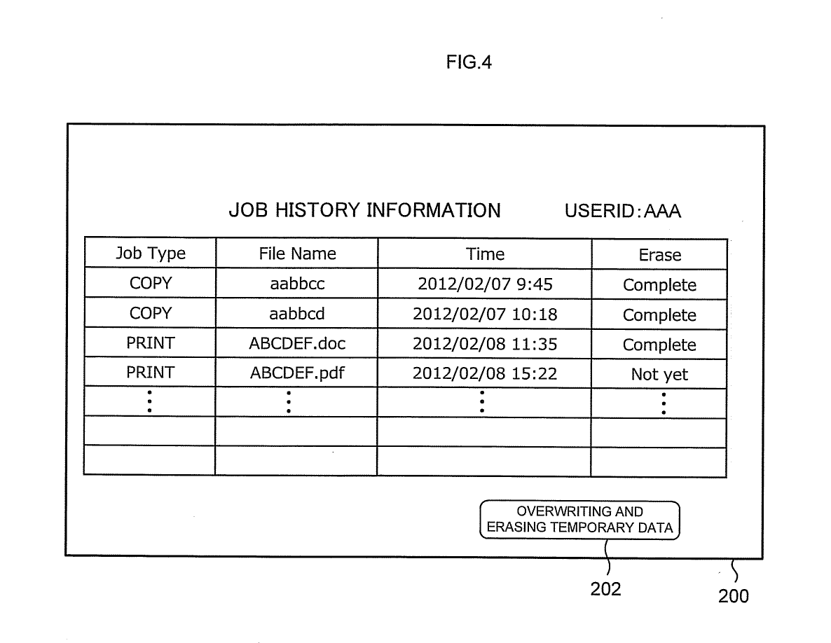

Here, an example of a job history screen 200 displayed by the display control section 106 is illustrated in FIG. 4. The job history screen 200 displays a job history of a user whose ID is AAA, for example. In the job history screen 200, Job Type illustrates the type of job that is carried out. The type of the job executed in the image forming apparatus 1 includes the copy, the print, the fax, the scan or the like. File Name is a file name of a file of the application that is a source of the job. Time is the date and time when the job was generated. Erase is information indicating whether or not the overwriting and erasing process is completed on the temporary data generated when each job is executed. “Complete” means that the overwriting and erasing process is completed, and “Not yet” means that the overwriting and erasing process is not yet performed in FIG. 4.

In the job history screen 200 illustrated in FIG. 4, the overwriting and erasing process is completed except a job (job of the PRINT job in fourth from the top) of a file name “ABCDEF.pdf”. The overwriting and erasing process is not executed on the fourth job by the instruction input from the user. Thus, the temporary data corresponding to the fourth job remains as is in the temporary data area 84 if the overwriting is not executed by other temporary data generated when other job generated.

Next, the operation input acquiring section 108 acquires the input from the operation panel 14 or the like. In the exemplary embodiment, the operation input acquiring section 108 acquires the input that the user instructs image forming apparatus 1 to execute the overwriting and erasing process with respect to the job where the overwriting and erasing process is not executed in the jobs displayed in the job history screen 200. The input of the execution instruction is performed in which for example, the touch panel 14a is touched to select the fourth job described above, and in the selected state, a “overwriting and erasing the temporary data” button 202 displayed on the screen is touched and depressed. The input instructing of the overwriting and erasing may be performed with other input unit such as the operation keys 14b.

If the operation input acquiring section 108 acquires the input to instruct the execution of the overwriting and erasing process, the temporary data management section 110 overwrites and erases the temporary data corresponding to the designated job with the predetermined data as the temporary data erasing section. The temporary data management section 110 specifies a position in the temporary data area 84 where the temporary data of the designated job is saved based on the position information of the temporary data saved in the temporary data management information area 83, and overwrites and erases the designated temporary data with the predetermined data.

When the overwriting and erasing process is executed, the display control section 106 changes the display from the display (Not yet) that the overwriting and erasing process is not executed on the temporary data to the display (Complete) that means the overwriting and erasing process is executed, with respect to the job corresponding to the temporary data where the overwriting and erasing process is executed in the job history screen 200.

The function of the image forming apparatus 1 of the exemplary embodiment is described above.

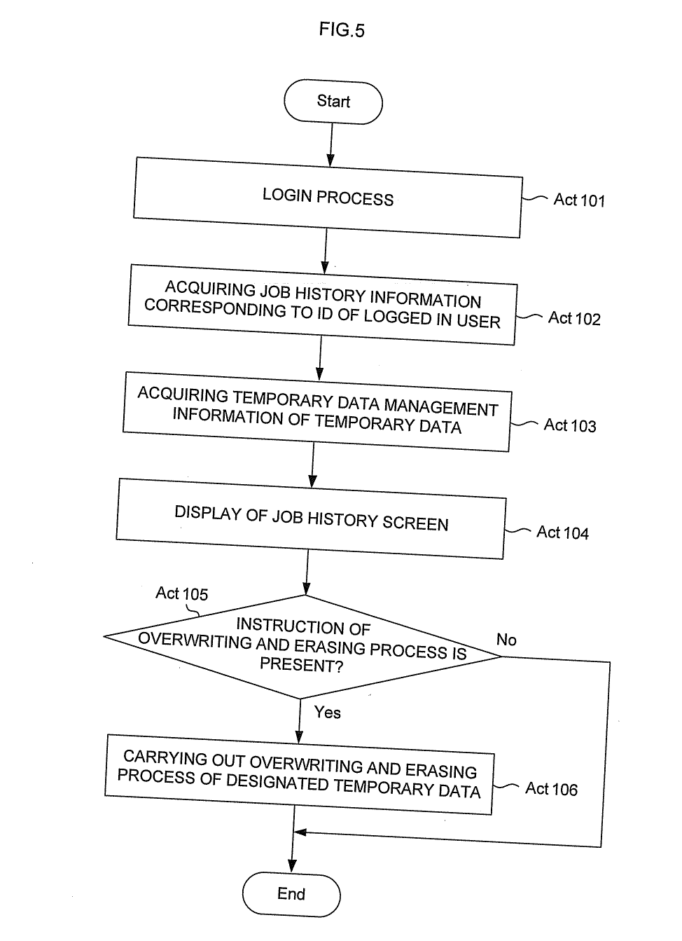

Next, flow of the management process of the temporary data in the image forming apparatus 1 is described. FIG. 5 is a flowchart illustrating the flow of the management process of the temporary data.

First, a login process is performed (Act 101) Specifically, the authentication process section 100 acquires the input such as the user ID and the password required in the login process from the operation panel 14. If the login process is performed by the ID card, the information stored in the ID card is acquired from the card reader or the like.

Next, the history information acquiring section 102 acquires the job history information of the job which is carried out by the ID of the logged in user from the auxiliary storage device 8 (Act 102)

Next, the temporary data management information acquiring section 104 acquires the temporary data management information of the temporary data corresponding to the job executed by the logged user (Act 103). Specifically, the temporary data management information acquiring section 104 acquires the information which specifies the job executed by the ID from the ID of the logged in user and the job history information which is acquired by the history information acquiring section 102. Thus, the temporary data management information acquiring section 104 acquires the information of whether or not the overwriting and erasing process is completed on the temporary data corresponding to the job that is executed by the logged in user, by the information specifying the ID and the job in the temporary data management information saved in the temporary data management information area 83.

Next, the display control section 106 displays the job history screen 200 using the job history information acquired in Act 102 and the information of whether or not the overwriting and erasing is completed which is acquired in Act 103 (Act 104). In the job history screen 200, the history of the jobs executed by the logged in user, and the information of whether or not the overwriting and erasing process is completed on the temporary data temporarily generated when each job is carried out are displayed in a list.

Next, regarding the displayed jobs, the determination is performed whether or not the input instructing execution of the overwriting and erasing process is performed in the operation panel 14 or the like (Act 105)

If the input instructing execution of the overwriting and erasing process is performed (Yes in Act 105), the temporary data management section 110 performs the overwriting and erasing process that overwrites and erases the temporary data of the job designated by the user with the predetermined data (Act 106)

Meanwhile, if the instruction to execute the overwriting and erasing process is not present (No in Act 105), the process is finished.

As described above, the flow of the management process of the temporary data in the image forming apparatus 1 of the exemplary embodiment is described.

Further, in the exemplary embodiment, the description is made that the temporary data of the logged in user is managed, however, the exemplary embodiment is not limited to the description. The temporary data corresponding to all jobs executed in the image forming apparatus 1 or the temporary data corresponding to the jobs executed by the user who is not logged in with a specific ID, such as a guest account, may be managed in the same method as the exemplary embodiment described above. For all jobs, the information of whether or not the overwriting and erasing process is completed on the temporary data of each job and the state of whether or not the overwriting and erasing is completed may be displayed on the job history screen, based on the information specifying all jobs. Further, for the job where the ID is not specified, such as the guest account, the information of whether or not the overwriting and erasing process is completed on the temporary data of each job may be acquired, based on the information specifying a job besides the job which is carried out by the specified ID. Thus, if the execution instruction of the overwriting and erasing process is performed, the image forming apparatus executes the overwriting and erasing process on the temporary data which is designated.

Accordingly, the temporary data may also be reliably erased and the security of the data may also be ensured on the job which is carried out without the authentication process or on the job which is carried out in the image forming apparatus where the authentication process is not performed.

Further, in the exemplary embodiment, the method of data management in the auxiliary storage device such as the HDD is described, however, the exemplary embodiment is not limited to the description. The method of data management of the exemplary embodiment may be applied similarly to a case where the temporary data is stored in the memory that is a main storage device or other storage devices.

Further, in the exemplary embodiment, description is made in which the storage device incorporated in the image forming apparatus 1 includes the temporary data area 84 or the temporary data management information area 83, however, the exemplary embodiment is not limited to the description. The outside storage device connected via the communication I/F 16 or the network 130 may have the areas.

According to the exemplary embodiment described above, the image forming apparatus may be provided having high security protection of the data.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
an operation input acquiring section which acquires operation input instructing to overwrite and erase temporary data of an image process object temporarily generated according to execution of a job with predetermined data;
a temporary data erasing section which performs an erasing process to overwrite and erase the temporary data designated by the operation input with the predetermined data;
a temporary data management section which manages in a predetermined storage area temporary data management information including at least information of whether or not the temporary data is erased in the temporary data erasing section;
a temporary data management information acquiring section which acquires from the predetermined storage area the temporary data management information which is managed in the temporary data management section; and
a display control section which displays on a screen the information of whether or not the temporary data is erased in the temporary data erasing section, correlated with history information of the job corresponding to the temporary data, based on the temporary data management information which is acquired in the temporary data management information acquiring section.

2. The apparatus according to claim 1,
wherein the operation input acquiring section acquires the operation to select the temporary data as an object to execute the erasing process in the screen displayed by the display control section and the operation instructing to erase the selected temporary data, and
the temporary data erasing section performs the erasing process with respect to the temporary data designated by the operation which is acquired in the operation input acquiring section.

3. The apparatus according to claim 1, further comprising:
a authentication process section which acquires identification information identifying at least a user and then performs an authentication process for using the image forming apparatus, and
wherein the temporary data management section manages the temporary data management information, correlated with the identification information of the user.

4. The apparatus according to claim 3,
wherein the temporary data management information acquiring section acquires from the predetermined storage area the temporary data management information, correlated with the identification information of the user who performed the authentication process, and
the display control section displays the information of whether or not the temporary data is erased, which is included in the temporary data management information acquired in the temporary data management information acquiring section, correlated with the history information of the job corresponding to the temporary data.

5. The apparatus according to claim 4, further comprising:
a storage device including a temporary data area temporarily saving the temporary data and a temporary data management information area saving the temporary data management information regarding the temporary data saved in the temporary data area.

6. The apparatus according to claim 5,
wherein the temporary data management information is information further including the identification information of the user who executed the job corresponding to the temporary data and position information where the temporary data is saved in the temporary data area.

7. A method of data management comprising:
acquiring an operation input instructing to overwrite and erase temporary data of an image process object temporarily generated according to execution of a job with predetermined data;
performing an erasing process to overwrite and erase the temporary data designated by the operation input with the predetermined data;
managing in a predetermined storage area temporary data management information including at least information of whether or not the temporary data is erased;
acquiring from the predetermined storage area the temporary data management information which is managed in the predetermined storage area; and
displaying on a screen the information of whether or not the temporary data is erased, correlated with history information of the job corresponding to the temporary data, based on the acquired temporary data management information.

8. The method according to claim 7, further comprising:
acquiring the operation to select the temporary data as an object to execute the erasing process in the displayed screen and the operation instructing to erase the selected temporary data; and
performing the erasing process with respect to the temporary data designated by the acquired operation.

9. The method according to claim 7, further comprising:
acquiring at least identification information identifying a user and then performing an authentication process of the user; and
managing the temporary data management information, correlated with the identification information of the user in the predetermined storage area.

10. The method according to claim 9, further comprising:
acquiring from the predetermined storage area the temporary data management information correlated with the identification information of the user who performed the authentication process; and
displaying the information of whether or not the temporary data is erased, which is included in the temporary data management information acquired in the predetermined storage area, correlated with the history information of the job corresponding to the temporary data.

11. The method according to claim 10, further comprising:
performing data management in a storage device including a temporary data area temporarily saving the temporary data and a temporary data management information area that is the predetermined storage area, saving the temporary data management information regarding the temporary data saved in the temporary data area.

12. The method according to claim 11,
wherein the temporary data management information is information further including the identification information of the user who carried out the job corresponding to the temporary data and position information where the temporary data is saved in the temporary data area.
